(19) United States
(12) Patent Application Publication
(10) Pub. No.: US 2006/0224430 A1
(43) Pub. Date: Oct. 5, 2006

(54) Agenda based meeting management system, interface and method

(75) Inventor: David Wesley Butt, San Jose, CA (US)

Correspondence Address: Trellis Intellectual Property Law Group, PC, 1900 EMBARCADERO ROAD, SUITE 109, PALO ALTO, CA, 94303, US

(73) Assignee: Cisco Technology, Inc., San Jose, CA (US)

(21) Appl. No.: 11/099,957

(22) Filed: Apr. 5, 2005

(51) Int. Cl. G06F 9/46

(52) U.S. Cl. 705/8

(57) ABSTRACT

A system, interface and method provide for agenda based meeting management that enables an agenda to be determined and utilized for managing one or more meetings that may include locally located participants, remote participants or both. Various embodiments enable meeting management to be conducted in an independent manner or in a composited manner with a conferencing or other meeting or support application or application data. Embodiments further provide for responding to user modification of a meeting or agenda item or group scheduling by automatically re-scheduling the meeting uncompleted agenda items or both according to the user modification. A management UI embodiment further provides a progress bar including a progress indicator and agenda indicia that may be disposed proximate to the progress indicator with spacing of the indicia being proportional to current agenda item scheduling. A more specific embodiment enables the progress bar to be used for tracking, controlling or modifying agenda portions.

### BACKGROUND OF THE INVENTION

1. Field of Invention

The present invention relates in general to the field of computing and more specifically to conferencing systems and methods.

2. Description of the Background Art

Electronic applications, such as computer programs, have long provided for establishing and maintaining a communication link among remotely located users participating in a meeting. Appointment and conferencing applications, for example, provide for setting an appointed time at which a meeting is to begin. Appointment applications may further inter-operate with participant calendars to determine appointed meeting time availability, and conferencing applications may further provide for establishing connections and distributing audio, video or other interaction media, thereby enabling participation in the meeting to occur.

Unfortunately, existing applications fail to address user progress during a meeting. Appointment applications, for example, are inapplicable once an appointment is set or initiated, and conferencing applications merely enable communication to occur among remotely located participants. As a result, meetings tend to meander, and individual presentations may be cut short or take an inordinate amount of time. Later presenters also have no reliable way of anticipating the start of their presentation, and it is often unknown when the end of the meeting might actually occur, leading to yet further problems in scheduling, use of conferencing resources, and so on.

Accordingly, there is a need for meeting management systems and methods that enable one or more of the above and/or other problems of conventional meetings to be avoided.

### SUMMARY OF EMBODIMENTS OF THE INVENTION

Embodiments of the present invention provide systems and methods for managing telephone, conferencing or other electronically facilitated or live meetings, thereby enabling conventionally encountered problems to be avoided. Various embodiments provide a meeting management user interface (UI), system and method that enable scheduling of a meeting agenda, presenting agenda portions to one or more participants, tracking meeting or agenda item progress, providing progress alerts, flags or notifications, and modifying an agenda to conform to participant progress during a meeting. Embodiments may be provided independently, interact with conferencing or other applications or be integrated with such applications, and the management UI may be presented in an independent, integrated or composited manner with such applications or presentations provided by such applications.

One graphically presentable UI embodiment provides for presenting a progress bar including a timing bar and agenda indicia to meeting participants. The progress bar may, for example, provide for indicating meeting/agenda timing and progress, and selecting agenda indicia to indicate agenda item completion status. The agenda indicia may, for example, be disposed proportionally along the progress bar to indicate agenda item scheduling.

The progress bar or portions thereof may also serve as a control for presenting meeting/agenda details or controls, enabling a coordinator or other participant to expedite or delay a start or end of a meeting or present further meeting/agenda controls. One or more agenda indicia or groupings thereof may further provide for enabling a coordinator or other participant to expedite, delay, add or delete corresponding agenda items, or preset further meeting/agenda controls. Management system embodiments may also automatically re-schedule a meeting or uncompleted agenda items and re-align corresponding indicia as needed. Automatic operation may, for example, conduct re-scheduling according to meeting/indicia modifications, participant priority or availability, and/or other factors. Other embodiments may further provide for conducting audio, video or other multimedia interfacing, re-scheduling notification, media access facilitating, security, pre-meeting and in-meeting participant notifications, connection assurance, other meeting management operations, or some combination thereof.

A meeting management method according to an embodiment of the invention provides for determining a meeting agenda of a meeting including at least two meeting participants. The meeting may, for example, include a phone call, presentation, lecture, conference or other participant interaction. The meeting agenda may include a scheduled absolute or relative timing of a meeting, as well as scheduled timing of one or more agenda items scheduled to be conducted during the meeting. The method further provides for receiving a progress indicator indicating at least one of a timing event and an agenda event. If the progress indicator indicates that an end time of the agenda item has passed and the agenda item has not been completed, then the method also provides for determining that an agenda item has overrun its scheduled timing, and alerting one or more of the participants that the agenda item has overrun its scheduled timing and/or automatically rescheduling at least one of the uncompleted agenda items.

A further meeting management method according to an embodiment of the invention provides for receiving a progress indicator indicating a modification of a start or end time of a meeting. The method further provides for notifying the participants of the modification (directly or via a suitable participant computing system), and may provide for conducting participant-facilitated or automatic re-scheduling as needed. The method may also provide for re-scheduling uncompleted agenda items, which rescheduling may be conducted according to relative scheduled time for uncompleted agenda items, a modified scheduled time for the meeting, participant priority or other raw or weighted rescheduling, other factors or some combination thereof.

Another meeting management method according to an embodiment of the invention provides for receiving a progress indicator indicating a modification of a scheduled presentation of an agenda item of a meeting. The method may notify the participants (directly or via a suitable participant computing system), and provides for re-scheduling uncompleted agenda items, or further re-scheduling the meeting (e.g., end time), which rescheduling may be conducted according to absolute or relative scheduled time for the uncompleted agenda items, a modified scheduled time for the meeting, participant priority or other weighted rescheduling, other factors or some combination thereof.

A meeting management system according to an embodiment of the invention includes a progress bar for receiving timing information and indicating a time progression corresponding to a conducting of a meeting. The meeting management system also includes agenda indicia disposed proximately to the progress bar. The agenda indicia may correspond to respective agenda items of the meeting or their complete or incomplete status, and their relative positioning may indicate a relative time for scheduled conducting of corresponding agenda items during the meeting. The agenda indicia may further operate as controls for enabling user display or manipulation of corresponding agenda items or groups of items. For example, lateral movement of an indicia that is laterally oriented with respect to other indicia in a graphical UI may cause the start of the corresponding item or the end of a preceding to be expedited or delayed, while vertical movement of the indicia may cause the item to be deleted or other progress bar or indicia invocation may cause additional information or controls to be presented. Expediting or delaying one or more indicia may further cause a meeting management engine to re-schedule remaining uncompleted items, among other examples.

A further meeting management system according to an embodiment of the invention provides means for determining a meeting agenda of a meeting of at least two participants, and means for receiving a progress indicator indicating at least one of a timing event and an agenda event. The meeting management system also includes means for determining that an agenda item has overrun its scheduled timing and alerting one or more of the participants that of the overrun and/or automatically re-scheduling at least one of the agenda items if the at least one progress indicator indicates that an end time of the agenda item has passed and the agenda item has not been completed.

A meeting management apparatus according to an embodiment of the invention provides a machine-readable medium having stored thereon instructions for determining a meeting agenda of a meeting of at least two participants, and for receiving a progress indicator indicating at least one of a timing event and an agenda event. If the at least one progress indicator indicates that an end time of the agenda item has passed and the agenda item has not been completed, then the apparatus also provides for determining that an agenda item has overrun its scheduled timing, and alerting one or more of the participants that the agenda item has overrun its scheduled timing and/or automatically re-scheduling at least one of the agenda items.

Advantageously, meeting management embodiments according to the invention enable electronic and/or live meeting participants to anticipate, track and/or modify agenda items or a meeting itself in an unobtrusive yet easy to use manner. Embodiments further enable meetings to be managed and thus conducted in more understandable, controllable and expeditious manner. Embodiments also enable agenda additions, deletions and/or other modifications to be manually or automatically determined and implemented quickly and easily, among other advantages.

These provisions together with the various ancillary provisions and features which will become apparent to those artisans possessing skill in the art as the following description proceeds are attained by devices, assemblies, systems and methods of embodiments of the present invention, various embodiments thereof being shown with reference to the accompanying drawings, by way of example only, wherein:

### BRIEF DESCRIPTION OF THE DRAWINGS

FIG. 1 is a flow diagram illustrating a meeting management enabled system according to an embodiment of the invention;

FIG. 2 is a flow diagram illustrating the meeting management system of FIG. 1 in greater detail, according to an embodiment of the invention;

FIG. 3 is a schematic diagram illustrating an exemplary computing system including one or more of the meeting management components of FIGS. 1 and 2, according to an embodiment of the invention;

FIG. 4a is a schematic diagram illustrating, in greater detail, the agenda determiner of FIG. 2, according to an embodiment of the invention;

FIG. 4b is a schematic diagram illustrating, in greater detail, the progress tracker of FIG. 2, according to an embodiment of the invention;

FIG. 4c is a schematic diagram illustrating, in greater detail, the event engine of FIG. 2, according to an embodiment of the invention;

FIG. 4d is a schematic diagram illustrating, in greater detail, the agenda updater of FIG. 2, according to an embodiment of the invention;

FIG. 4e is a schematic diagram illustrating, in greater detail, the management user interface (UI) of FIG. 2, according to an embodiment of the invention;

FIG. 4f is a schematic diagram illustrating, in greater detail, the security-preference engine of FIG. 2, according to an embodiment of the invention;

FIG. 4g is a schematic diagram illustrating, in greater detail, the application interface of FIG. 2, according to an embodiment of the invention;

FIG. 4h is a schematic diagram illustrating, in greater detail, the manager controller of FIG. 2, according to an embodiment of the invention;

FIG. 5a illustrates a meeting management UI, according to an embodiment of the invention;

FIG. 5b illustrates an agenda detail editor of a meeting management UI according to an embodiment of the invention;

FIG. 5c illustrates a further agenda detail editor of a meeting management UI according to an embodiment of the invention;

FIG. 5d illustrates a progress bar of a meeting management UI according to an embodiment of the invention;

FIG. 6 is a flowchart illustrating a meeting management method according to an embodiment of the invention;

FIG. 7a is a flowchart illustrating a method for conducting a meeting scheduling modification including one or more agenda item modifications, according to an embodiment of the invention;

FIG. 7b is a flowchart illustrating, in greater detail, a method for modifying one or more agenda items in conjunction with a meeting scheduling modification, according to an embodiment of the invention;

FIG. 8a is a flowchart illustrating a method for conducting an agenda item scheduling modification, according to an embodiment of the invention;

FIG. 8b is a flowchart illustrating, in greater detail, a method for modifying one or more agenda items in conjunction with an agenda item scheduling modification, according to an embodiment of the invention; and

FIG. 9 is a flowchart illustrating a method for modifying one or more agenda items in conjunction with an agenda modification, according to an embodiment of the invention.

### DETAILED DESCRIPTION OF EMBODIMENTS OF THE INVENTION

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer” for purposes of embodiments of the present invention may include any processor-containing device, such as a mainframe computer, personal computer, laptop, notebook, microcomputer, server, personal data manager or “PIM” (also referred to as a personal information manager or “PIM”) smart cellular or other phone, so-called smart card, settop box or any of the like. A “computer program” may include any suitable locally or remotely executable program or sequence of coded instructions which are to be inserted into a computer, well known to those skilled in the art. Stated more specifically, a computer program includes an organized list of instructions that, when executed, causes the computer to behave in a predetermined manner. A computer program contains a list of ingredients (called variables) and a list of directions (called statements) that tell the computer what to do with the variables. The variables may represent numeric data, text, audio or graphical images. If a computer is employed for synchronously presenting multiple video program ID streams, such as on a display screen of the computer, the computer would have suitable instructions (e.g., source code) for allowing a user to synchronously display multiple video program ID streams in accordance with the embodiments of the present invention. Similarly, if a computer is employed for presenting other media via a suitable directly or indirectly coupled input/output (I/O) device, the computer would have suitable instructions for allowing a user to input or output (e.g., present) program code and/or data information respectively in accordance with the embodiments of the present invention.

A “computer-readable medium” for purposes of embodiments of the present invention may be any medium that can contain, store, communicate, propagate, or transport the computer program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. The computer readable medium may have suitable instructions for synchronously presenting multiple video program ID streams, such as on a display screen, or for providing for input or presenting in accordance with various embodiments of the present invention.

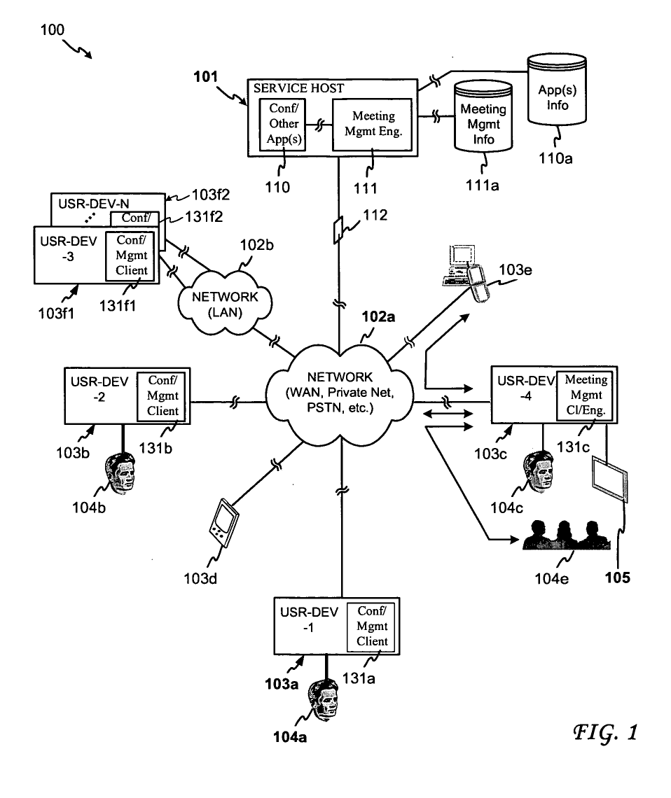

Referring now to FIG. 1, there is seen a flow diagram illustrating examples of meeting management enabled meeting systems (meeting systems) according to an embodiment of the invention. Meeting system 100 broadly provides for conducting a meeting participant interaction or “meeting” during which one or more meeting participants may interact or “meet,” and the progress of which meeting may be coordinated or otherwise managed by a meeting management system, e.g., 110,131x. The meeting system may, for example, operate in an otherwise conventional manner for setting a meeting appointment, establishing any necessary connections or data transfer among meeting participants, or otherwise generally facilitating interaction among meeting participants. A live or combined live and conference, telephone call or other electronically facilitated meeting may also be conducted. The meeting management system (management system) 110, 131x provides for determining a scheduled agenda that may include the meeting and agenda items to be conducted during the meeting, and for monitoring, modifying or otherwise facilitating participant progress through the agenda.

Note that the term “or” as used herein is intended to include “and/or” unless otherwise indicated or unless the context clearly dictates otherwise. The term “portion” as used herein is further intended to include “in whole or contiguous or non-contiguous part” which part can include zero or more portion members, unless otherwise indicated or unless the context clearly dictates otherwise.

In accordance with an embodiment of the invention, a meeting appointment or meeting environment may be set or conducted in an otherwise conventional manner by a meeting program, computing system or other device(s) or “meeting application.” A meeting application may, for example, include but is not limited to one or more of conferencing, scheduling appointments, establishing telephone connections, remote presentation/education, or other meetings that may include remotely located participants (remote participants).

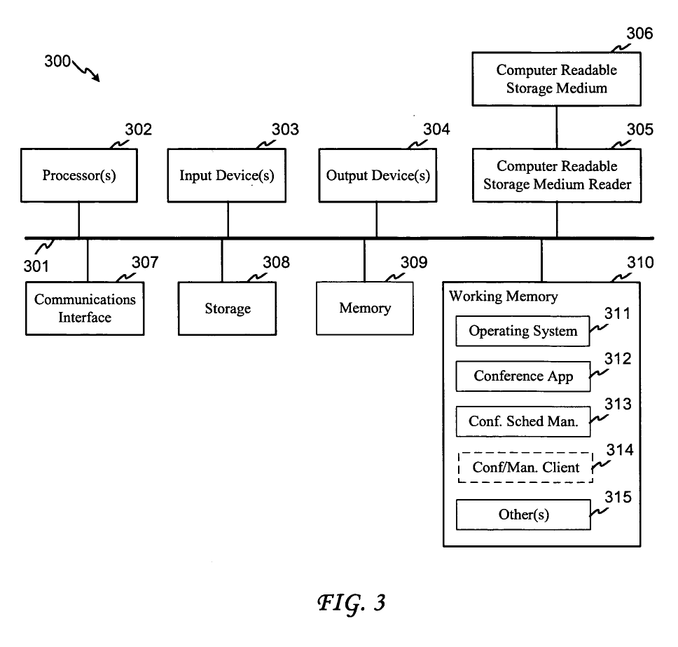

The management system may be implemented, in whole or part, in an independent, inter-operable or integrated manner with meeting, communications or supporting applications or application data. A management user interface corresponding to the management system may further be implemented, in whole or part, in an independent, inter-operable, integrated or composited manner with such application or application data. One or more of meeting application or management system portions may further be implemented as locally or remotely operable code, hardware or some combination thereof. (See, for example, FIG. 3.) As shown in FIG. 1, meeting system 100 in one remote management embodiment includes communicatingly coupleable components including service host 101, storage 112a, 112b, one or more networks 102a, 102b, and two or more participant devices 103a-f. Service host 101 may, for example, include one or more intra-network or end device computing systems that is/are capable of hosting a conferencing application 110 and a meeting management engine 111. Service host 101 is coupled via network 102a to user devices 103a-d, and via networks 102a and 102b to user devices 103e1 through 103e2.

It will be appreciated that storage, processing or other resource requirements for conducting conferencing are well known. It will also become apparent that resource requirements for implementing basic meeting management are negligible by comparison, particularly for a management client (see below), and may be easily implemented using a conventionally equipped PC, or even emerging conventionally equipped PDAs, cell phones or other portable devices.)

Within service host 101, conferencing application 110 may, for example, include a conventional conferencing or other participant interaction (meeting) system that is operable in an otherwise conventional manner for coupling and providing audio/video or other multimedia conferencing features via one or more of networks 102a, 102b to two or more participant users of user devices 103x. Conferencing application 110 may also include one or more of appointment, email, file transfer, dialing, white/blackboard capability, messaging or other support features, or be coupleable to applications providing such features in an otherwise conventional manner, or some combination, in accordance with the requirements of a particular application.

Supporting features may also provide for synchronization, device coordination, security or various protocols for supporting IP, conventional, cellular or satellite phones, integrated devices or various other participant devices or device interaction. Such participant devices may, for example, include PDAs, smart phones or other devices having limited storage, processing or display, audio or other presentation capabilities. Specialized support for such devices may, for example, include limited capability device servers, such as those currently used for receiving and reducing or converting program code, data, display/audio or other information for presenting Web pages or related media, or otherwise providing other limited capability device support, and for supplying suitably modified information to such devices. Such servers or other suitable support may also be used in a similar manner, abet for a new purpose in conjunction with meeting management.

Conferencing application 110 may also provide so-called “hooks” for enabling other applications to utilize various conferencing application features, for example, in accordance with the discussion herein. The hooks may, for example, be implemented in an otherwise conventional manner using an application program interface (API), add-on protocol, storage polling/sharing, and so on, or some combination. In the present example, hooks may be used to facilitate meeting management system operation and may, for example, provide for distribution of a common timing reference, compositing of an optional solid or opaque meeting management system UI within conference data (e.g., supporting participants who may view meeting progress) or within conferencing controls (e.g., supporting participants having general or specialized meeting management control permissions).

Meeting manager (manager) 111 provides for tracking, coordinating or otherwise managing participant progress through a scheduled meeting agenda. The agenda, in one embodiment, includes a meeting and meeting agenda item schedule including one or more topics or other meeting sub-divisions (hereinafter, agenda items) that are or may become scheduled to be conducted during a meeting. At least an initial agenda is typically determined prior to a meeting that may include a start time and end time of a meeting, as well as agenda item start and end times, or further, meeting/agenda item presenter or audience participants, participant or agenda item priority, permissions, preferences, attending/not-attending status, associated media, topic or other agenda information corresponding to one or more participants, agenda items or groups thereof.

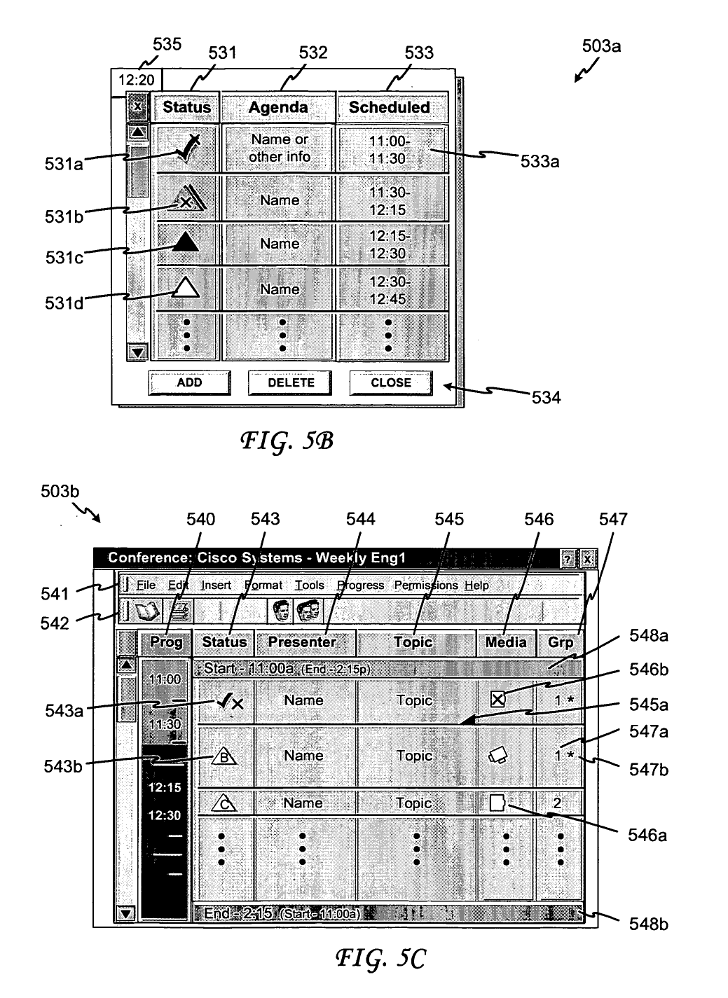

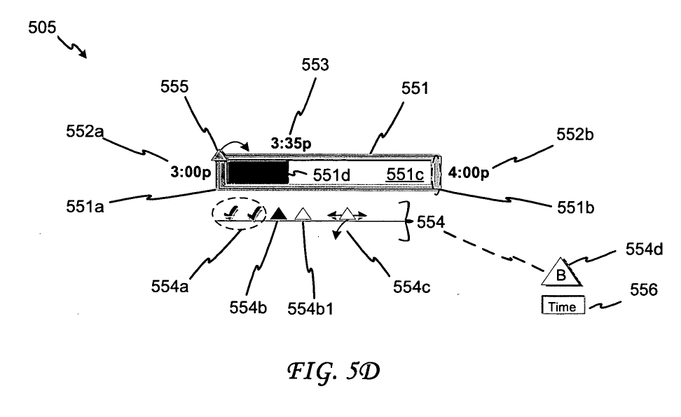

Manager 111 may, for example, determine an agenda by receiving available information via a hook to an appointment, conferencing or other application, or by polling or parsing email, notes, other correspondence, other documents or some combination (e.g., see above). Other mechanisms or some combination may also be used. Available information may, for example include an appointed meeting start time, end time, invited/confirmed meeting participants, their coupling to the meeting (e.g., connection), and so on. Manager 111 may receive available information automatically (e.g., programmatically) or responsively to user initiation. Manager 111 may also extract meeting or agenda item information from one or more of received spreadsheet, correspondence, word processing, notes or other documents, for example, by parsing a predetermined localization of such documents, polling one or more participants or some combination. Parsing may, for example, be conducted according to one or more of predetermined formats, keywords, forms or sets of rules, and so on, or some combination. Alternatively or in conjunction therewith, manager 111 may also provide an agenda interface for enabling participant entry of agenda information. See, for example, FIG. 5a below. (It should be noted that an integrated manager may also provide for receiving an agenda item portion from a meeting application operating in accordance with the discussion herein. It should also be noted that the participants may also include persons or devices that may attend a meeting or “attending participants,” those who may not attend a meeting or “non-attending participants,” and so on.)

Manager 111 further provides for tracking progress through a meeting agenda. In one embodiment, manager 111 agenda progress tracking includes the use of a time reference event and a completion event. The time reference event may, for example, include manager 111 receiving a time reference from a conference program, other meeting application, clock or other timing source. The time reference may be received periodically, intermittently or continuously. Alternatively or in combination therewith, manager 111 may, at similar intervals, poll a service engine or other device or application for a clock or other time reference indicator, the initiation or receipt of which may also constitute a (common) time reference event. Implementation of periodic, intermittent or continuous receipt or polling may, for example, be determined according to available bandwidth, processing resources, other criteria or some combination, and may be utilized in the same or different manners in conjunction with different devices.

In one embodiment, manager 111 distributes a progress timing indicator via one or more of networks 102a-b to participant devices 103x, which indicator may correspond with a time reference event. Manager 111 may, for example, conduct such distribution via direct transfer or a meeting application hook (e.g., initiating such transfer). A management client 131x operating on a corresponding participant device receives the indicator and correspondingly updates a management system UI progress indicator, e.g., an elapsed time indicated by the below discussed management UI progress bar. Alternatively or in combination therewith, the timing indicator may be provided by a conference or other meeting application and similarly processed by a receiving management client, determined by a management client of a participant device, and so on, or some combination. (It will be appreciated that manager 111 may further provide for presenting the above or other progress information via a manager host.)

In another embodiment, manager 111 compares a received time reference to at least one scheduled agenda item timing parameter and may correspondingly initiate alerts or flags, or conduct agenda re-scheduling, for example, according to one or more management system preferences. (Flags may be stored or otherwise used for maintaining meeting records, training or for other purposes, while alerts are typically presented to one or more participants according to management system preferences or participant permissions.)

For example, agenda item timing parameters may include a scheduled end time of an agenda item currently being conducted (current agenda item), and one or more warnings or flags may be initiated or “issued”: if the time reference is within a predetermined time interval of the scheduled end time of the current agenda item (e.g., proximity alert/flag), if the scheduled end time for the agenda item has passed and an agenda item has overrun its scheduled end time (e.g., overrun alert/flag); if an agenda item has been completed prior to its scheduled end time (e.g., expedited alert/flag); if a start of an agenda item is delayed (e.g., delayed alert/flag); and so on. The time interval may, for example, be set to zero or more seconds, or may be determined according to criteria in accordance with the requirements of a particular application, or some combination. Other alerts or flags or some combination may be also provided in accordance with the requirements of a particular application.

Manager 111 may further cause an initiated alert or flag indicator to be presented to a portion of the participants, for example, in accordance with management system preferences or participant permissions. Manager 111 may, for example, directly transfer a corresponding alert or flag indicator to a corresponding participant device 103× or cause such indicator(s) to be transferred by meeting application 110. A management client 131x receiving such indication may respond by causing a received warning or flag to be presented or stored, for example, according to management client preferences. Alternatively, such alerts or flags may be presented by meeting application 110, for example, as composited meeting data or a separate control, or some combination may be used.

In a further embodiment, manager 111 may respond to an overrun-item or expedited-item condition by automatically re-scheduling one or more agenda items or a meeting end time, or by issuing one or more corresponding alerts/flags. For example, manager 111 is configurable for extending or expediting (moving forward or shortening) the end time of a current meeting by a time interval corresponding to the overrun or expedited-item. Manager 111 may also be configured to determine whether one or more other pending or otherwise uncompleted agenda items has also been delayed and reschedule the current and other agenda item(s) as well as the meeting end time. The uncompleted agenda items may, for example, be expedited or extended by a total time interval corresponding to a current agenda item overrun or expediting. Manager 111 further provides for transferring a corresponding update indicator to participant devices 103x and for a receiving client 131x to receive and present the update, for example, in a similar manner as with the above time event updating Such rescheduling may, for example, be conducted continuously or periodically, or rescheduling based on other conditions may be conducted, or some combination, in accordance with the requirements of a particular application.

In yet another embodiment, manager 111 provides for enabling a portion of the participants to conduct agenda modifications or to provide other management events, which modifications or events may further initiate automatic manager operations. For example, a participant having a sufficient level of permissions (permissioned participant) may manually initiate a proximity, overrun or other warning or flag, which warning or flag may be conditionally transferred and presented by participant devices in the manner already discussed for automatic proximity/overrun operation. A permissioned participant may also indicate that an agenda item has been completed. In this case, an event receiving management client may, for example, replace a presented scheduled completed item indicia with a presented completed-item indicia (e.g., see FIG. 5a).

Manager 111 may further provide for permissioned participant modification of one or more agenda items or groups of agenda items. In this example, manager 111 may respond by correspondingly updating the meeting end time, or further, by also automatically modifying scheduling of one or more uncompleted agenda items. Manager 111 may also issue one or more corresponding alerts/flags. Manager 111 automatic modification may, for example, re-schedule the agenda items by respective time intervals corresponding to the relative times originally scheduled for the agenda items.

A raw percentage modification implementation may, for example, extend or shorten an uncompleted agenda item that is currently scheduled to occupy 15 minutes of an hour meeting by twenty five percent of the modification time interval. A 12 minute expedited completion of a current agenda item may therefore add 3 minutes to the scheduled time for presenting the uncompleted agenda item. Other uncompleted agenda item scheduling may be updated in a similar manner.

Alternatively, a weighted percentage modification implementation may modify the raw percentage by an amount corresponding to a predetermined weight value, calculation or other parameter. Such weighting may, for example, correspond to a priority that is assignable to a presenter participant or audience participant (e.g., a visiting executive), or an agenda item or agenda item group (e.g., critical issues to be discussed). For example, a 12 minute expedited time interval of a current agenda item may extend an uncompleted agenda item scheduled for 15 minutes of an hour presentation and having a 1/12 weighted extension by 25 percent plus 1/12 of 12 minutes or 4 minutes. Other updating mechanisms or some combination may also be used or may be rendered subject to management system preferences in conjunction with participant or other modification or event updating.

Manager 111 may also respond in a similar manner to participant modification that extends or expedites a meeting. For example, manager 111 may respond to a permissioned meeting extension by conducting the participant modification, or further providing for automatic operation according to raw, weighted or other parameters or some combination. If, for example, a meeting extension adds a 12 minute time interval to the meeting, manager 111 may, in accordance with management system parameters, extend a current agenda item by 12 minutes, add a percentage raw extension to each uncompleted agenda item, add a weighted percentage extension to each uncompleted agenda item, and so on, or some combination. Alternatively, manager 111 may, in this and other examples providing for automatic or otherwise variable operation, request a participant selection from among available operational alternatives. Manager 111 further provides for transferring a modification event indicator to one or more corresponding (e.g., permissioned) management clients, which clients may update a participant presentation, for example, in the manner already discussed. (It will be appreciated that similar modifications and updating may also be conducted for adding an agenda item, canceling an agenda item or other modifications that may be desirable in accordance with a particular application.

Of the remaining meeting system 100 components, networks 102a and 102b may, for example, include one or more of suitable fixed or reconfigurable physical or virtual networks including local area networks (LANs), private networks, wide area networks (WANs, e.g., the Internet), and so on, or some combination. Firewall 112 is illustrative of a wide variety of security mechanisms, such as firewalls, encryption, fire zone, compression, secure connections, one or more of which may be used in conjunction with various system 100 components. Many such mechanisms are well known in the computer and networking arts.

Participant devices may include any suitable devices for coupling to a suitable network as needed, conducting applicable communication during a meeting and conducting applicable meeting management operations. Management clients 131 may, for example, include a Web browser, add-on or dedicated management code for providing the above-discussed operations or further related operations, and may be implementable as locally executeable code, a downloadable, applet, servlet or other mobally executeable code, hardware or some combination. Clients 131 may also be used in an integrated manner with meeting or other meeting or support application clients or other code or some combination may be used in accordance with the requirements of a particular application.

FIG. 1 also illustrates a further local management system embodiment in which a locally executable management system may be utilized in conjunction with a conventional telephone call, locally managed conference or local meeting. A first example includes a personal computer, Web phone, conferencing appliance or other multifunction participant device 103c implementing an Internet or other network telephone (meeting) application (not shown for clarity sake) and manager 131c. Participant 104c may initiate manager 131c and an initial agenda may be determined via participant 104c entry or automatic (e.g., programmatic) operation of manager 131c. Participant 104c may further initiate the meeting application and initiate a “dialing” operation to telephone and thus “meet” with a user of participant device 103e. Manager 131c may then, in response to connection to device 103e (e.g., as indicated by a communications device, via a meeting application hook and so on), provide for transferring a management client application or corresponding Web pages to participant device 103e, or device 103e may implement a local management client. In other respects, manager 131c may operate in a similar manner as discussed above with complete permissions being assignable participant 104c, or further, to the user of device 103e.

In another example, one or both of participant devices 103c and 103e may include more than one computing system or other device for conducting a telephone (i.e., or video or other) meeting and conducting meeting management. For example, a first device may include a conventional or cellular phone while a second, synchronized or unsynchronized device operates as a host for implementing a management engine 131c or management client (e.g., device 103e) respectively. Network 102a may further include a public switched telephone network (PSTN) for conducting the telephone call and an internet protocol (IP) network for conducting meeting management. Manager 131c and a corresponding client of devices 103e may then be initiated, an agenda determined, and operation may proceed as in the previous example, abet with any telephone information being transferred via the PSTN network and any management system information being transferred, as needed, via the IP network.

In a third example, participant 104c conducts a live local meeting in which a management system 131c hosted by a suitable device 103c is operable by participant 104c or one or more of participants 104e for managing the live meeting. As with the previous examples, manager 131c may also inter-operate with other applications, for example, in the manner already discussed. It will be appreciated that management system 131c may operate in a similar manner as with the above discussed management engine examples, but may also provide for presenting management information rather than transferring such information to a management client. It will further be appreciated that participant 104c may utilize a local management system in conjunction with telephoning or other various meeting applications, for example, for conducting local progress tracking or for other purposes in accordance with a particular implementation.

Management system 131c further provides for implementing meeting management operations provided by more than one host. For example, a live meeting may be extended to include remote participants or a first meeting, such as a conference, may be continued as a live meeting. In such cases, management system 131c is configurable for transferring meeting management information in an otherwise conventional manner to a new host. A first device may therefore host a management system of a first meeting and a second host may host a management system during an extended (i.e., or continued) meeting, or more than one management system instance or some combination may be utilized.

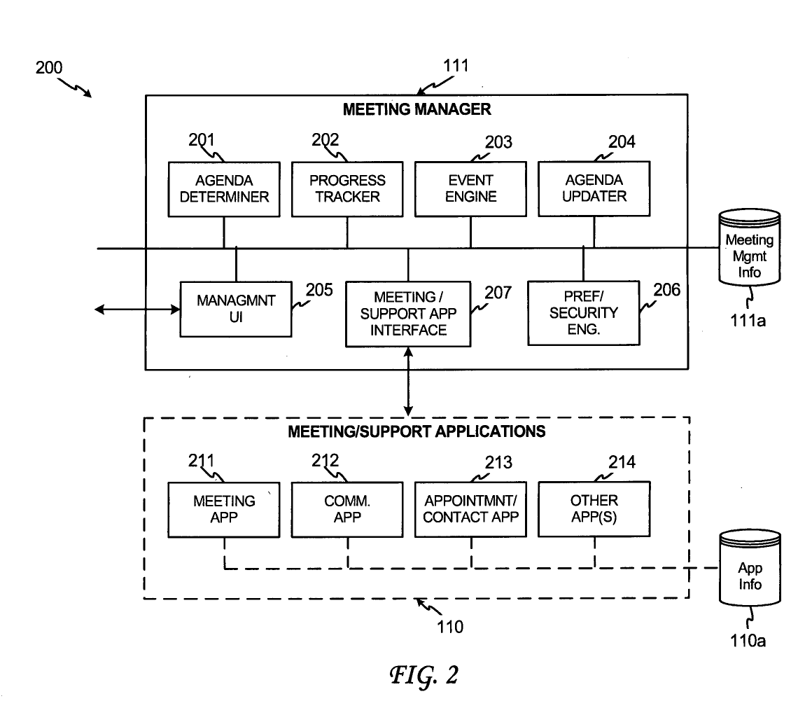

The FIG. 2 flow diagram illustrates in greater detail how one embodiment of manager 111 of FIG. 1 may comprise coupled components including agenda determiner 201, progress tracker 202, event engine 203, agenda updater 204, management UI 205, permission engine 206 and meeting application interface 207. Manager 201 may also be coupled to meeting management storage 111a and to one or more meeting or support applications 202, which applications may further be coupled to one another and to application information storage 110a.

Within manager 111, agenda determiner 201 provides for determining an initial agenda and for responding to agenda modifications received from agenda updater 204 by modifying the agenda, or further transferring update indicators to management UI 205, a management client or both. Progress tracker 202 provides for receiving a clock or other timing indicator from a meeting application, hosting device or other timing source, or a progress event from event engine 203 (e.g., indicating a completed event). Progress tracker also provides for determining (e.g., calculating) progress as needed and transferring one or more timing or event indicators to management UI 205, a management client or both.

Event engine 203 provides for responding to a participant event received via management UI 205 or a management client, or to an automatic event, by initiating one or more of agenda determiner 201, progress tracker 202 or agenda updater 204 and providing a corresponding event indicator. An event may, for example, include a timing, progress or progress modification event, an agenda item/meeting proximity, cancellation, addition or other alert or flag to one or more of presenter, audience or other participants of a corresponding agenda item/participant or group (e.g., enabling such participant to join a meeting in progress or otherwise utilize scheduled time for a corresponding agenda item/meeting portion), and so on.

Agenda updater 204 provides for responding to a participant event received via management UI 205 or a management client, or to an automatic event, by determining agenda modifications (e.g., extending or expediting agenda items or a meeting end time) and transferring an indicator indicating the determined modification(s) to agenda determiner 201 for implementation.

Management UI 205 provides an interactive user interface (UI) through which a participant may enter agenda information or events and may be presented with agenda or progress information. An embodiment of management UI 205 is, for example, discussed in greater detail with reference to FIGS. 5a through 5c.

Preference engine 206 provides for receiving participant and management system permission, priority and preference information, and for providing indicators of such information to the remaining manager system components. For example, permissions may enable or prevent participant agenda entry or modification, or presentation to one or more participants of agenda detail portions, presentation media portions, media version portions, other meeting detail portions, and so on.

Priority may also be assignable to one or more of participants, participant groups, agenda items or agenda item groups. Priority may, for example, include providing additional time or lesser reduced time for a corresponding agenda item presentation. Priority may also include re-ordering or otherwise re-scheduling one or more preceding agenda items, or providing an alert or flag, hereinafter “bumping” a higher priority item/group, to better assure sufficient time to present one or more higher priority agenda items (e.g., where an overrun causes insufficient time for such presentation), and so on. Preferences, such as time reference polling, progress reporting, agenda re-scheduling, assignment of priority, and so on, may be assignable in a static or dynamic manner that may, for example, be subject to processing/throughput resources or other factors. Each of the remaining manager 111 components 201-205 and 207 may be operable according to one or more of the above permissions, priorities or preferences, for example, as was already discussed, or others may be used or some combination, in accordance with the requirements of a particular implementation.

Application interface 207 provides for manager 111 or a management client transferring data to/from a meeting, support application or other resource (also referred to herein as an application), or initiating or receiving events or controls from such application. Meeting or support applications may, for example, include but are not limited to meeting applications 110 (e.g., conferencing, dialing, and so on), communication applications 221 (e.g., email, messaging, and so on), appointment or contact applications (e.g., appointment scheduling, calendaring, address book, and so on) or other applications. For example, progress tracker 202 and event engine 203 may be implemented for responding to proximity, overrun, expedited, addition, cancellation or other condition or event by determining corresponding participant contact information of a not present participant via a contact application hook and issuing a corresponding alert to the participant using the determined participant contact information. Other examples will also become apparent to those skilled in the art in view of the discussion herein.

FIG. 3 further illustrates a computing system embodiment that may comprise one or more of the components of FIGS. 1 and 2. While other alternatives might be utilized, it will be presumed for clarity sake that components of systems FIG. 1, FIG. 2 and elsewhere herein are implemented in hardware, software or some combination by one or more computing systems consistent therewith, unless otherwise indicated.

Computing system 300 comprises components coupled via one or more communication channels (e.g. bus 301) including one or more general or special purpose processors 302, such as a Pentium®, Centrino®, Power PC®, digital signal processor (“DSP”), and so on. System 300 components also include one or more input devices 303 (such as a mouse, keyboard, microphone, pen, and so on), and one or more output devices 304, such as a suitable display, speakers, actuators, and so on, in accordance with a particular application.

System 300 also includes a computer readable storage media reader 305 coupled to a computer readable storage medium 306, such as a storage/memory device or hard or removable storage/memory media; such devices or media are further indicated separately as storage 308 and memory 309, which may include hard disk variants, floppy/compact disk variants, digital versatile disk (“DVD”) variants, smart cards, partially or fully hardened removable media, read only memory, random access memory, cache memory, and so on, in accordance with the requirements of a particular implementation. One or more suitable communication interfaces 307 may also be included, such as a modem, DSL, infrared, RF or other suitable transceiver, and so on for providing inter-device communication directly or via one or more suitable private or public networks or other components that can include but are not limited to those already discussed.

Working memory 310 further includes operating system (“OS”) 311, agenda determiner 312, progress tracker 313, event engine 314, agenda updater 315, management UI 316, application interface 317 and may include other programs 318, which may be stored or loaded therein during use. The particular OS may vary in accordance with a particular device, features or other aspects in accordance with a particular application, e.g., using Windows, WindowsCE, Mac, Linux, Unix, a proprietary OS, and so on. Various programming languages or other tools may also be utilized, such as those compatible with C variants (e.g., C++, C#), the Java 2 Platform, Enterprise Edition (“J2EE”) or other programming languages. Such working memory components may, for example, include one or more of applications, add-ons, applets, servlets, custom software and so on for conducting but not limited to the examples discussed elsewhere herein. Other programs 318 may, for example, include one or more of security, compression, synchronization, backup systems, groupware code, and so on, including but not limited to those discussed elsewhere herein. Other programs 318 may also include a network client (e.g., browser) or other program code for conducting manager or management client operations in conjunction with a management system.

When implemented in software, a meeting, meeting management system or other component may be communicated transitionally or more persistently from local or remote storage to memory (SRAM, cache memory, etc.) for execution, or another suitable mechanism may be utilized, and elements can be implemented in compiled or interpretive form. Input, intermediate or resulting data or functional elements may further reside more transitionally or more persistently in a storage media, cache or other volatile or non-volatile memory, (e.g., storage device 308 or memory 309) in accordance with a particular application.

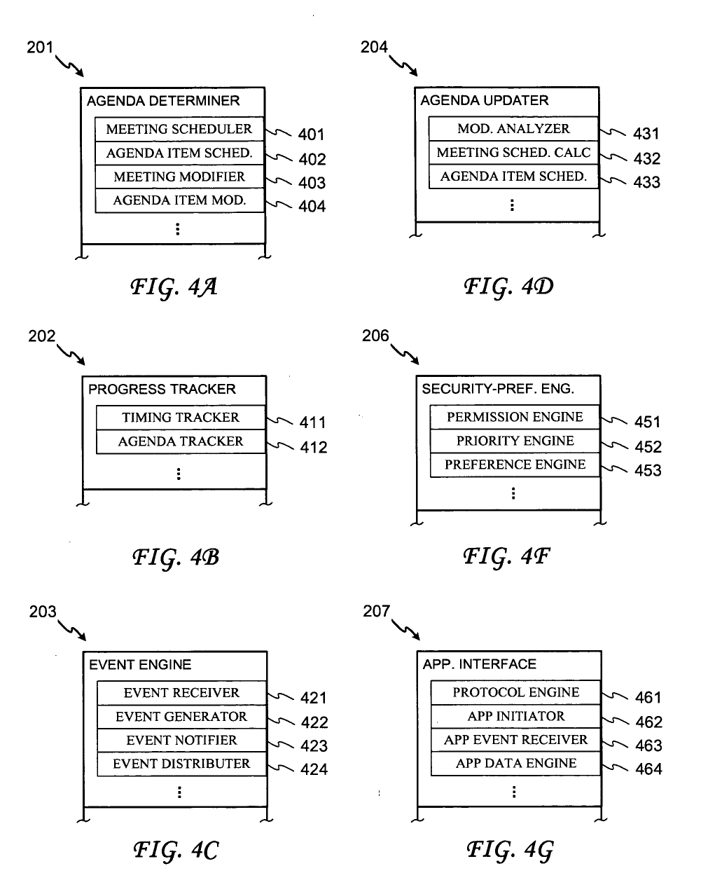

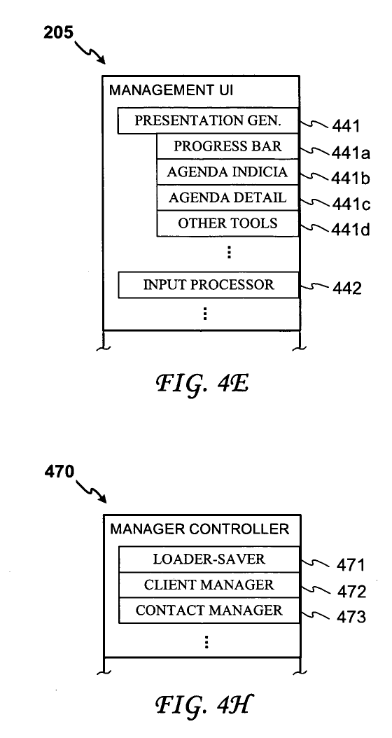

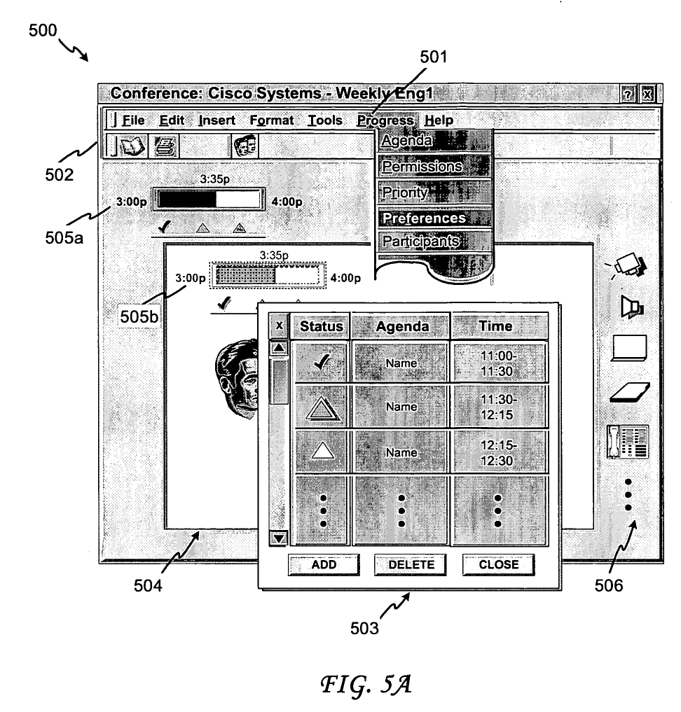

FIGS. 4a through 4g illustrate, in greater detail, embodiments of components of manager 111 of FIG. 2, while FIG. 4h illustrates a manager controller embodiment.

Beginning with FIG. 4a, agenda determiner 201 includes meeting scheduler 401, agenda item scheduler 402, meeting modifier 403 and agenda item modifier 404. Meeting scheduler 401 and agenda item scheduler 402 provide for entering or retrieving initial agenda information corresponding to a meeting or agenda item(s) respectively. Schedulers 401 and 402 further provide for invoking loader-saver 471 (FIG. 4h) to store or retrieve such information, and for providing scheduling or other such information to other manager 211 components. Meeting modifier 403 and agenda item modifier 404 similarly provide for responding to progress, event, scheduling or other modifications determined by other manager 211 components by modifying agenda information corresponding to a meeting or agenda item(s), and for invoking loader-saver 471 for storing or retrieving such information.

Progress tracker 202 of FIG. 4b includes timing tracker 411 and agenda tracker 412. Timing tracker 411 provides for conducting receiving or polling of a timing source (e.g., via support interface 207) or otherwise determining timing information, and for further generating a timing update indicator for updating manager or management client timing or progress tracking/presentation (e.g., via management UI 205 and client manager 464. Agenda tracker 412 provides for conducting other meeting and agenda item tracking, and similarly invokes management UI 205 and client manager 464 for providing local or remote updating respectively. Such tracking and updating may, for example, include the above noted tracking of agenda item completion, adding, canceling bumping or other modifications affecting meeting/agenda item progress.

Event engine 203 of FIG. 4c includes agenda event receiver 421, agenda event generator 422, event notifier 423 and event distributor 424. Agenda event receiver 421 provides for receiving participant or application events and invoking event notifier 423 or event distributor 424. Event notifier 423 provides for determining whether notification should be provided to a meeting participant, and if so, for initiating client manager 464; client manager 464 invokes contact manager 463 for determining a participant location and contact information, and further distributes the notification to at least one corresponding participant device as needed (e.g., according to stored participant location and contact information). Event generator 422 provides for generating the above noted automatic manager events, and event distributor 423 provides for causing event, flag or condition indicators to be distributed to corresponding participant devices (e.g., via communication interface 307 of FIG. 3).

Agenda updater 204 of FIG. 4d includes modification analyzer 431, meeting schedule modification calculator 432 and agenda item schedule modification calculator 432. Modification analyzer 431 provides for analyzing an agenda in accordance with an event, flag, condition or modification and determining therefrom one or more agenda modifications to be conducted. Modification analyzer 431 more specifically invokes permission engine 451 of preference engine 206 to determine, if a modification is initiated by a user, whether the user is permitted to initiate such modification. If the modification is permitted, modification analyzer 431 further determines agenda information that may be modified in accordance with a received modification initiation and invokes priority and preference engines 452, 453 to determine any priorities or preferences that may apply to the modifications. Modification analyzer 431 further invokes a corresponding one or more of meeting modification calculator 432 and agenda item calculator 433 to conduct applicable meeting or agenda item modification determinations. Modification analyzer 431 also invokes applicable event engine 203 components for generating applicable events or notifications and conducting any applicable event or notification distribution. Meeting schedule modification calculator (meeting modifier) 432 provides for determining modifications to meeting scheduling (e.g., percentage, prioritized, weighted, and so on) or other meeting modifications, while agenda item schedule modification calculator (agenda item modifier) 433 provides for determining modifications to agenda item scheduling or other agenda item modifications.

Management UI 205 of FIG. 4e includes presentation generator 441 and input processor 442. Presentation generator 441 provides for modifying received meeting, participant or agenda item information for presentation (e.g., scaling, recalculating, and so on), and generating a presentation or transferring the information to a participant device UI generator for presentation generation. Presentation generator 441 may, for example, generate GUI or other interface presentations that may include audio, graphic, video or other multimedia components (e.g., see FIG. 3). In a more specific example, presentation generator 441 includes progress bar generator 441a, agenda indicia generator 441b, agenda detail generator 441c and other tools generator 441d, which respectively provide for presenting a progress bar, agenda indicia, appended or newly presented agenda details and other progress management tools (e.g., see FIG. 5a). Input processor 442 provides for receiving entered participant control/data information via the presented UI and transferring the entered information to corresponding ones of manager 111 components.

Security-preference engine 206 of FIG. 3f provides for responding to other manager 111 components by determining permissions, priorities or preferences corresponding to a manager 111 operation. Within security-preference engine 206, permission engine 451 provides for determining whether a management system operation is permissible according to current permission settings and returning a corresponding permission indicator. Permissions may, for example, be applicable to a participant or the management system performing an operation portion or being presented with a portion of the results of an operation, or otherwise in accordance with the requirements of a particular implementation. Priority engine 452 provides for determining whether a priority should be applied to a management system operation. Priority may for example, be applicable for shortening an agenda item presentation by a lesser time interval or extending an agenda item by a greater time interval than may otherwise be used, resolving a conflict in favor of a higher priority participant or agenda item, and so on, in accordance with the requirements of a particular implementation. Preference engine 453 provides for determining a management system preference that may apply to a management system operation.

Application interface 207 of FIG. 4g provides for manager 111 conducting communication with a meeting, support or other application, for example, as was already discussed. Within application interface 207, protocol engine 461 provides for determining a mechanism or connection for conducting communication with such an application, for example, determining a suitable protocol, format, application hook, storage descriptor, API, and so on.

Application initiator 462 provides for manager 111 initiating an application control, while application event receiver 463 provides for receiving from an application a management system event or control and application data engine 464 provides for conducting data transfer to/from a corresponding application.

Finally, manager controller 470 of FIG. 4h provides for management system control features and includes loader-saver 471, client manager 472 and contact manager 473. Loader-saver 471 provides for responding to other manager 111 components by temporarily or more persistently storing and retrieving meeting management information (e.g., to/from storage 111a of FIG. 1). Meeting management information may, for example, include an initial or modified agenda, participants, security information (e.g., presentation/modification permissions), participant information (e.g., participants, presenter/audience level status, location, connection, participant device operational parameters, and so on), system information (e.g., bandwidth/resources), and so on, in accordance with the requirements of a particular implementation. Client manager 472 provides for conducting information transfer to/from a management system or other client either directly or via an application, service host or other device, while contact manager 464 provides for determining a parameters for conducting such communication. Such parameters may, for example, include an indicator indicating a corresponding application for providing such information (e.g., address book, document, etc.), a client location, connection information, and so on.

Turning now to FIG. 5a, there are seen examples of a meeting management UI 500 according to an embodiment of the invention. A similar management UI may further be used in conjunction with a management system manager or client, or manager or client interfaces may vary in accordance with the requirements of a particular application. For example, interface 500 may be implemented to provide a less complex graphical display, other media, other environments, and so on, or some combination.

Management UI 500 includes a progress management menu 501 and toolbar buttons 502, as well as an agenda detail editor 503 and progress bar 505a or 505b. Management UI 500 may also include other tools 506 in accordance with the requirements of a particular implementation. The entire management UI or some portion may further be integrated with a meeting or other application (e.g., using an API, add-on protocol, and so on) in an otherwise conventional manner. Progress management menu 501 and toolbar buttons 502 provide for accessing various management UI control or data entry operations, and may be configured in a linear, hierarchical or other suitable manner or include fixed or selectable components including all or a portion of such operations.

Agenda detail editor 503a provides for participant entry or review of an initial or modified agenda. As shown in the FIGS. 5b and 5c examples, an agenda detail editor may be include only agenda scheduling details, or may include presentation, connection, location, media or other details, or some combination thereof.

Management UI 500a includes fixed or configurable status indicia including status information 531, agenda item information 532 and agenda item scheduling information 533. Status information 531 provides for presenting to a participant an ongoing progress status of a meeting or each agenda item of the meeting and, in the present example, provides for completed item indicia 531a, current item indicia 531b, delayed initiation or completion indicia 531c and scheduled item indicia 531d.

One or more of the status indicia may further include status detail indicia indicating deviation of an item from a initial or modified schedule (e.g., an added “x”) or other status information. Size, shape, color, audio or other media or media parameters may also utilized in accordance with a particular presentation implementation. Agenda information 532 may further include presenter, location, topic or other information, and scheduling 533 may include a time, sequence or other absolute or relative scheduling of one or more agenda items, either or both of which may also include further detail indicia. One or more of the indicia may be sorted, switched, appended or otherwise modifiable via column/row header activation or other suitable mechanism(s). The illustrated management UI 503a also includes controls for adding or deleting items 534 and a current time indicator 535.

The agenda detail editor 503b of FIG. 5c illustrates a further agenda detail editing interface that may be implemented as an independent management UI or integrated with a meeting or other application, and that may include menu 541 and toolbar 542 components. Agenda detail editor 503b provides for modifying agenda details according to a continuous progress scheduling provided by progress bar 540, selective fixed or relative placement of agenda item indicia with respect to progress bar 540 (here, time increments) and meeting progress indicators 548a-b. (Agenda information may, for example, be scheduled or rescheduled by alignment of corresponding agenda item indicia with progress bar 540.)

Editor 503b indicia also provides for continuous presentation of more comprehensive agenda information than editor 503a. For example, static or configurable presenter information indicia 544 and topic indicia 545 are presented separately, and media indicia 546 and participant group indicia 547 are added. Additionally, status indicia 543 provide for including status detail indicia in a readily apparent manner, such as item labeling (e.g., 543b), thereby facilitating addition, deletion, re-ordering or other indicia item modifications. Presentation information 545 also provides for separately presenting topic, source, support materials or other presentation information, and topic or other detail indicia may include a presentation modification detail indicia 545a indicating that a corresponding presentation aspect has been modified. Documents, slideshow or other media may also be coordinated or tracked, for example, using media selection indicia 546a or unavailability detail indicia 546b. Sub-meeting or other grouping support is further provided by way of grouping indicia 547 that may, for example, include a group number 547a as well as connection, location or notification, or other group detail indicia. (Thus, for example, a meeting may include sub-meetings having the same or different participants, which participants may be automatically or selectively notified at or prior to their scheduled participation in a meeting or sub-meeting portion.) Other implementations will also become apparent in view of the present discussion.

Returning to FIG. 5a with further reference to FIG. 5d, progress bar 505 includes progress indicator 551, meeting indicia 552, 553, and status indicia 554, 555, and may further include other indicia (e.g., 556) or controls (e.g., 553) that may further be presented in conjunction with progress bar utilization. Progress bar 503a, 503b may be implemented in a fixed or configurable manner according to particular device capabilities, and may, for example, provide for participant monitoring of progress through an agenda, or further, for directly or indirectly conducting agenda re-scheduling or other management system operations, e.g., in conjunction with suitably capable devices. An integrated or floating progress bar 505a may, for example, be integrated with meeting or other application controls, or a composited progress bar 505b may be composited within meeting or other application controls or data.

Progress bar 505 of FIG. 5d, for example, includes a thermometer-like agenda progress indicator 551 that is bounded by meeting indicia 552a, 552b and status indicia 554 that are disposed proximate to the progress indicator. Progress indicator 551 includes a meeting duration indicator 551c and a time progression indicator 551d that traverses the meeting duration indicator to provide an indication of the passage of time or some other durational indicator during a meeting. Meeting indicia 551a, 552a provide modifiable indications of a meeting start time, while meeting indicia 551b, 552 provide modifiable indications of a meeting end time. In one GUI implementation, for example, a meeting start and end time are presented in a relative manner by indicia 551a-b, and may be modified by moving (e.g., dragging) indicia 551a or 551b laterally to a later or earlier progress bar 505 time/duration indication. Meeting start and end times are also presented in a more discrete or absolute manner by indicia 552a-b, which indicia may also be modified by selecting indicia 552a or 552b and entering a respective new time. (As noted, timing may be maintained in a common or independent manner for use by participant devices.) A relative current time/duration indication is presented by a continuous or intermittent traversal of progression indicator 551d or a leading indicator end portion across meeting duration indicator 551c, while a discrete or absolute current time may be continuously or intermittently provided by meeting indicia 553 (e.g., presented responsively to a mouse-over or other invocation of progress bar 505.)

Status indicia 554 of one embodiment correspond to respective agenda items and are disposed proportionally about the length of progress indicator 551, whereby the relative spacing of a status indicia corresponds to a start time of a corresponding agenda item with respect to the start time of a meeting, or the relative duration of corresponding agenda items. Thus, for example, a participant viewing progress bar 505 may determine at a glance that status indicia 554a and 554b correspond with a series of agenda items that begins at about the start of the illustrated meeting and includes agenda items having a duration of about half that of the indicia 554b1 duration. If desired, the participant may further invoke an indicia (e.g., via mouse-over or some other control) to view one or more corresponding agenda item details (e.g., start, end, duration, presenter, topic, group, and so on, or some combination). The details may, of course, vary in accordance with management system parameters or otherwise in accordance with a particular implementation. The particular indicia utilized may also express agenda item, meeting, presenter or other details. For example, the illustrated embodiment provides a check mark as a completed item detail indicia, a blank shape as a scheduled item detail indicia, and grayed/colored, resized or otherwise modified or appended shapes as overrun, expedited, delayed or other detail characteristics. (Other media may also again be utilized or some combination thereof.) In another embodiment, an agenda item title detail indicia is also included in conjunction with a portion of the status indicia (e.g., 554d).

Status indicia 554 and 555 further provide controls with which a permissioned participant may modify scheduled agenda items. For example, progress bar 505 causes a current scheduling of an agenda item to be modified according to a permissioned participant moving a status indicia along the length of progress indicator 551 and thereby modifying its spacing relative to the meeting start or other status indicia (with optional presenting of a start time, end time or duration of a corresponding agenda item). Progress bar 505 also provides for displaying a similarly operable entry field (e.g., 556) in response to permissioned participant activation of an agenda item, and for deleting an agenda item that is moved vertically out of general horizontal alignment with the other status indicia (e.g., a virtual status bar). Progress bar 505 further provides a new agenda item well 555 for causing a new agenda item to be added according to a user actuating well 555 or positioning a well component (e.g., icon) to a position on the virtual status bar. Other controls or media or some combination thereof may also be used in accordance with a particular implementation.

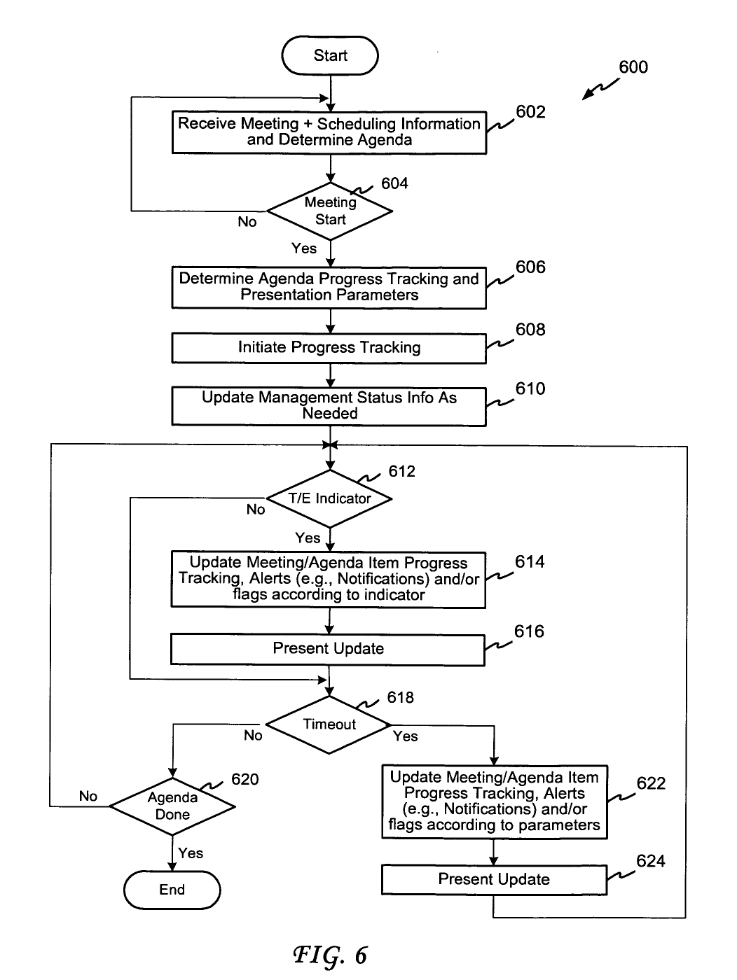

The FIGS. 6 through 8 flowcharts illustrate meeting management methods that may be performed by a suitable integrated, independent, composited or combined management system or management UI portion according to embodiments of the present invention.

Beginning with FIG. 6, in block 602, the management system receives meeting and scheduling information, and determines a meeting agenda corresponding to the meeting. Management operations continue in block 606 in conjunction with a received meeting start event in block 604. In block 606, the management system determines agenda progress tracking and presentation parameters, which parameters may also include agenda preference, modification, permission or other management parameters. In block 608, the management system initiates agenda progress tracking, and in block 610, the management system updates management status information as needed. Management status information (info) may, for example, be configurable in accordance with management parameters and may include confirming current presenter, audience or participating participant group connection to (i.e., or presence in) the meeting to participate in one or more agenda items, media presence, connection or other availability, starting an agenda item, and so on. Status information may further include timing, alert, flag or other automatic management system time/event generation, for example, as was already discussed, and which generation may be further operated upon in accordance with steps 612-616.

If, in block 612, the management system receives a time/event indicator (i.e., or has generated one or more in steps 610 or 612), then the system updates meeting/agenda item progress tracking, alerts or flags according to the indicator in block 614. For example, a received timing indicator may be tracked or cause a presenter device to be updated. A participant, media or other unavailability or delay in starting an agenda item may also result in generation of an alert or flag or may further cause an automatic re-scheduling that “ripples” through other affected (e.g., uncompleted) agenda items or the meeting itself, for example, as illustrated in the following figures, and so on. Such responses are then distributed, locally provided or otherwise presented to one or more applicable participants as an update in accordance with any corresponding permissions, priorities or preferences in block 616.

Similar procedures may also result if an indicator is not received in step 612 and an agenda item start delay or end overrun or other timeout condition (or “event”) is determined to occur in block 618. In a more specific embodiment, the management system updates meeting/agenda item progress tracking, alerts or flags in block 622, abet according to the timeout and any applicable stored timeout or other parameters. The management system further similarly presents a corresponding update in block 624.

If instead a timeout does not occur in block 618, then the method proceeds with determining whether the agenda has been completed or the meeting is ended in block 620. If the agenda has been completed or the meeting is ended in block 620, then the method ends; otherwise the method returns to block 612.

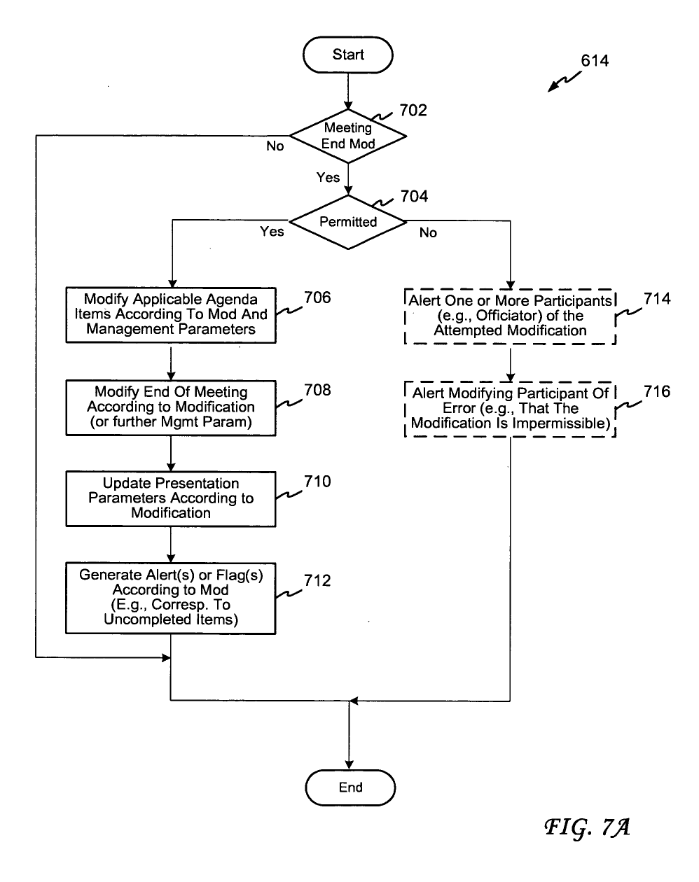

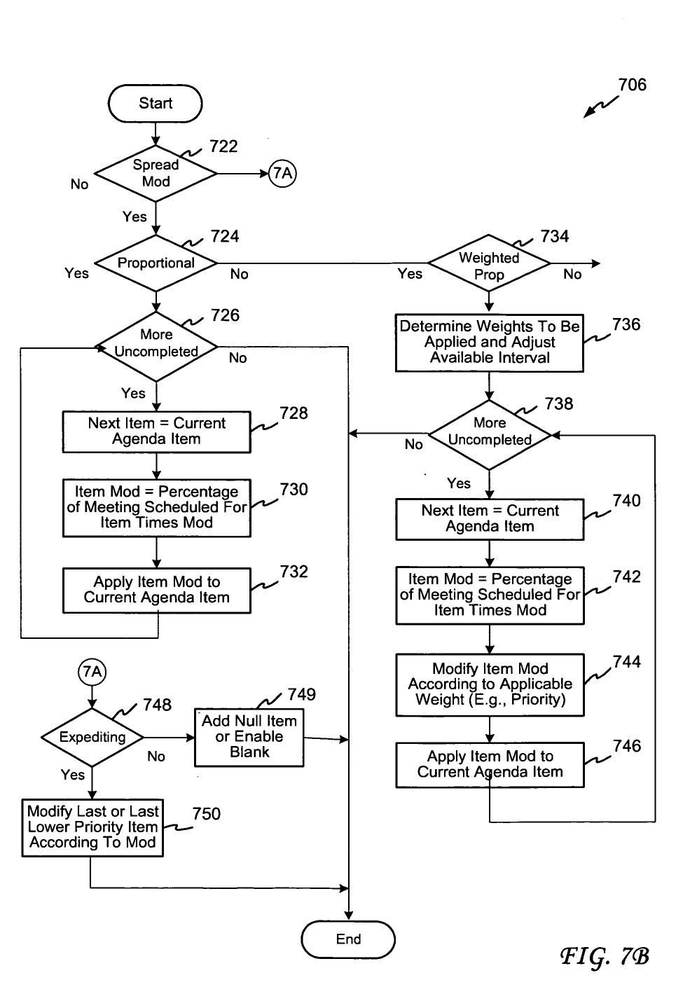

FIG. 7a further illustrates how an exemplary method for responding to a received meeting end modification event (block 702) includes determining whether an attempted participant modification is permissible in block 704. If not, then the management system may, according to management parameters, alert one or more participants of the attempted modification in block 714 or alert the modifying participant of an error condition, e.g., impermissible modification, in block 716.

If instead the modification is permissible, then the management system modifies applicable agenda items in block 706 (e.g. see FIG. 7b), modifies a scheduled end of meeting in block 708, updates presentation parameters according to the modification in block 710 and generates any applicable alerts or flags in block 712. The alerts or flags may further be presented in accordance with block 616 of FIG. 6.

As illustrated in the exemplary agenda item update method of FIG. 7b, block 706 of FIG. 7a may include determining whether an expedited meeting end, overrun (i.e., or delayed) meeting end or other meeting end modification is to be spread among uncompleted agenda items in block 722. Such determination may, for example, be determined according to management parameters or some other mechanism, thereby enabling a wide variety of actions may be taken or alerts or flags to be automatically generated in accordance with a particular implementation. The remainder of FIG. 7b illustrates only a few examples of actions that may be taken in spreading (or not) an excess or reduced available time interval resulting from a meeting end modification. It will be appreciated, in view of the above discussion, that one or more agenda items may also be bumped, i.e., deleted or moved ahead of behind one or more others, or other actions may also be taken in accordance with a particular implementation.

For example, a time interval corresponding to a meeting end modification (modification time interval) may be automatically spread across remaining uncompleted agenda items according to the proportional spreading of blocks 726 through 732 or the weighted proportional spreading of blocks 736 through 744. Proportional spreading includes, if more uncompleted agenda items remain to be updated in block 726, identifying the next such agenda item as a current agenda item in block 728. Proportional spreading also includes determining an item modification as a percentage of the meeting that is scheduled for the current agenda time multiplied by the modification time interval in block 730 and applying the item modification to the current agenda item in block 732.

Alternatively, weighted proportional spreading may include, determining a total weighting to be applied to one or more of the uncompleted agenda items being modified and adjusting the available modification time interval in block 736. Note that, in a positive weighting embodiment, a weighting corresponding to a meeting end overrun increases a proportional current item modification while a weighting corresponding to an expedited meeting end decreases a proportional current item modification. Thus, for example, a higher priority agenda item may be increased by a greater amount or decreased by a lesser amount responsive to a meeting modification. (It will be appreciated that negative weighting may also be similarly applied, for example, to increase a lower priority proportional or other item modification by a lesser amount or to decrease the lower priority item modification by a greater amount). If more uncompleted agenda items remain to be updated in block 738, then a next such agenda item is determined to be a current agenda item in block 740. A current item modification is further determined as a percentage of the meeting that is scheduled for the current agenda time multiplied by the available modification time interval in block 742, the weighting is applied to the current agenda item modification in block 744 and the current item modification is added, multiplied or otherwise applied to the current agenda item, e.g., according to management parameters, in block 746.

A variety of actions may also be taken if, in block 722, the meeting end modification is not to be spread among agenda items. One embodiment, for example, provides that, if in block 748 the meeting end modification is an expediting modification an shortens the meeting, then one or more of the last agenda items or the last agenda items determined to have a lower or lowest priority is modified, i.e. shortened, by an item modification corresponding to the meeting end modification; otherwise, if the meeting end is overrun and extended, then rather than extending one or more agenda items, an unscheduled time interval is created or a null agenda item is scheduled at the end of the meeting. It will be appreciated that an expedited or other end modification may result in modification of one or more agenda items, for example, if the expediting shortens the meeting by more than the scheduled interval of the last (lower priority) agenda item or a time remaining for an agenda item is less than some predetermined/preferred minimum time interval for conducting the agenda item.

Meeting start modifications or start and end modifications may, for example, be conducted in a similar manner as with meeting end modifications.

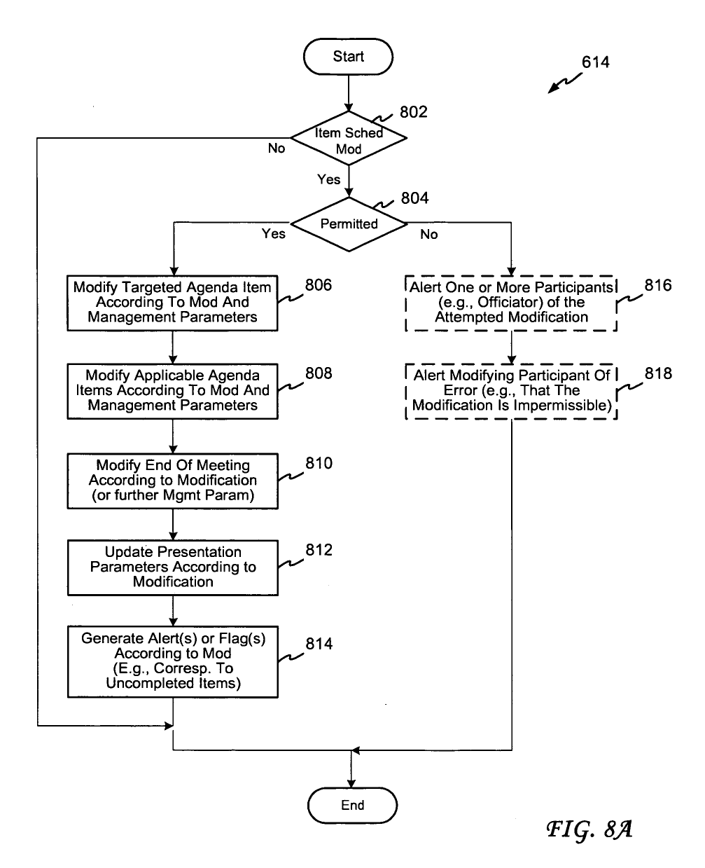

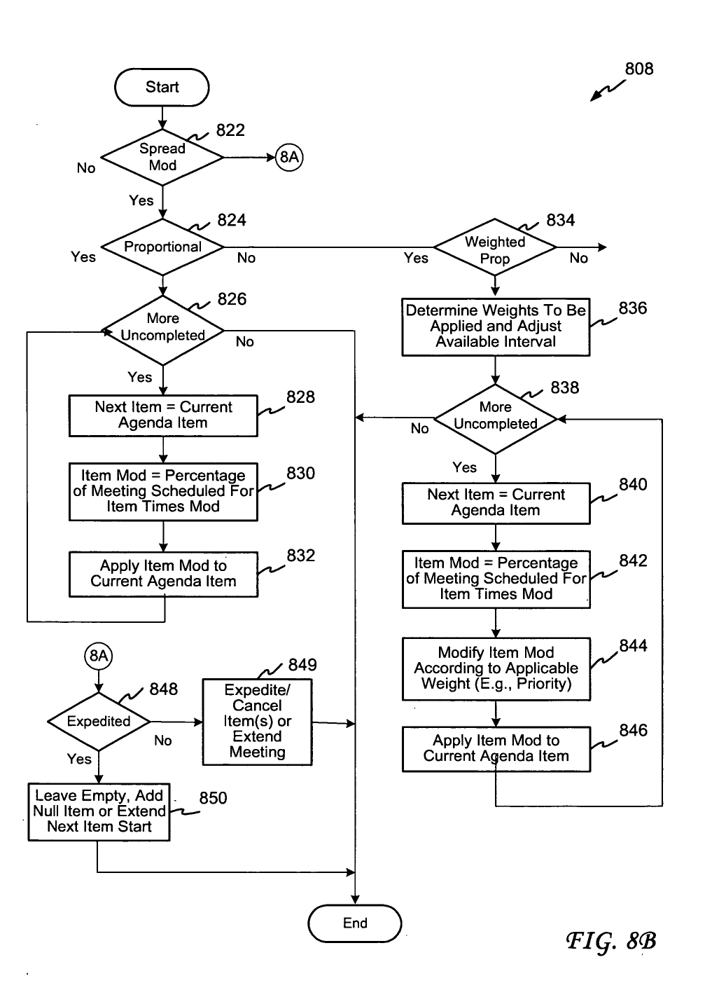

As shown in FIG. 8a, item scheduling modifications may also be conducted in a similar manner as with the FIG. 7a meeting end modifications. Permission for conducting an agenda item modification may be similarly assured prior to enabling a modification to occur or alerts or flags may further be provided if such permission is lacking, as illustrated by blocks 804 and 816 through 818. The target, here a targeted agenda item, may further be modified generally or according to predetermined extent or other limitations in block 806, as with the FIG. 7a meeting end modifications.

Block 808 further provides for modifying applicable uncompleted agenda items according to the modification and any management parameters. Thus, for example, a management system may respond to an expedited targeted agenda item end by expediting or extending one or more successive agenda items, bumping a later agenda item according to participant availability, an early scheduling request, priority or other parameters, and so on. A management system may also respond to an overrun targeted agenda item end by shortening a next agenda item, spreading the lesser available time interval, bumping, canceling, and so on, according to management parameters. Similarly, block 810 provides for modifying an end of meeting according to the item modification, or further according to management parameters. Thus, an expedited agenda item end may expedite an end of meeting or not, a delayed agenda item end may overrun an end of meeting or not, and so on, in accordance with parameters provided or selected in accordance with a particular implementation. Blocks 812 and 814 further respectively illustrate how presentation updating and alert or flag generation may be conducted in a similar manner as with the FIG. 7a meeting end modifications. It will also be appreciated that an agenda item start modification, addition or deletion may also be conducted in substantially the same manner.

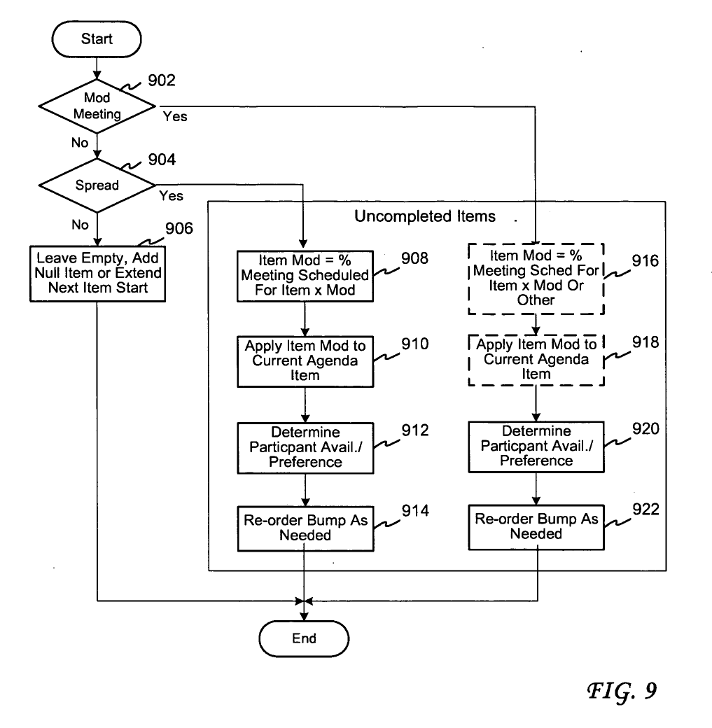

FIGS. 8b and 9a through 9b further illustrate examples of how modification of an agenda item or other modifications may be impacted by meeting length constraints, participant availability constraints or application of bumping or other management features. Beginning with FIG. 8b, spreading the scheduling impact of an expedited or overrun agenda item, or an agenda item addition or deletion among other agenda items may be conducted in substantially the same manner as in the meeting end modification example of FIG. 7b-particularly if meeting length, availability or other factors are not considered. For example, if spreading of an agenda item end modification is permitted in block 822, then a proportional modification spreading (block 824) may include, for each uncompleted agenda item (block 826) determining a next agenda item as a current agenda item in block 828, determining a current item modification as the scheduled percentage of the meeting scheduled for the item in block 830 and applying the item modification in block 832. Weighted or other modification spreading may also be conducted as discussed with regard to the FIG. 7b. If spreading is not utilized in block 822, however, an expedited agenda item end will result in an empty meeting portion, which portion may, for example, remain empty or be filled by inserting a null agenda item or by extending a next (or other) agenda item schedule so that the item starts at about the end of the previous agenda item, among other examples.

The FIG. 9 example also provides for responding to an agenda item modification in which an agenda item modification expedites a prior scheduled agenda item end time. For clarity sake, however, proportional spreading of the modification is presumed. Other spreading may also be used. The FIG. 9 example further illustrates utilization of availability priority or preferences, and further provide for simple bumping in which an item may be re-scheduled to an earlier time according to participant availability, priority or preferences.

As shown in FIG. 9, responsive modifications that may be performed by a management system include determining whether modification of a corresponding meeting is permitted (block 902). If so, then block 904 determines whether spreading is to be applied. If applied, then blocks 908 through 914 may be conducted. An item modification is determined in block 908 for all of the uncompleted agenda items other than the target agenda item, and in block 910, the modifications are applied to the respective uncompleted agenda items. Block 912 further provides for determining the availability of participants corresponding to the uncompleted agenda items. Availability may, for example, be conducted according to stored availability or participant preference information (e.g., that a participant prefers to participate earlier or later) or by polling, responsive alerts or other mechanisms, or may further be conducted according to participant priority (e.g., whereby a higher priority participant's preferences may be considered first or given priority). Block 914 provides for conducting re-ordering of the uncompleted agenda items according to the determined availability (or preferences).

If instead, in block 902, a meeting end time may be modified, then blocks 916 through 922 may be conducted. Blocks 916 through 922 differ from blocks 908 through 914 in that determining or applying an item modification is optional or the manner of such determining or applying may be conducted according to factors other than the length of a meeting. For example, since the meeting may be cut short or otherwise modified, uncompleted agenda item scheduling need not be conducted or may be conducted according to other meeting progress facilitating criteria without consideration for strictly maintaining a current meeting end time. Availability, preferences or priority and re-ordering may otherwise be conducted as with blocks 908 through 914.

If a meeting may not be modified in block 902 or spread in block 904, then the unscheduled meeting time or “gap” resulting from the agenda item modification may be resolved by inaction (leaving an unscheduled meeting time), extending one or more agenda items to fill the gap, or by adding a null agenda item in block 906, according to preferences or other parameters provided by a particular implementation.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A meeting management method, comprising:
determining, by a management system, a meeting agenda of a meeting of at least two participants, the meeting agenda indicating a scheduled timing of one or more agenda items to be conducted during a meeting and a scheduled timing of the meeting;
receiving, by the management system, at least one progress indicator indicating at least one of a timing event and an agenda event; and
automatically rescheduling, by the management system, at least one of the agenda items if the at least one progress indicator indicates that an agenda item end time differs from its scheduled end time.

2. A meeting management method according to claim 1, wherein a progress indicator indicates at least one of an agenda item overrun and an expedited agenda item.

3. A meeting management method according to claim 1, wherein the determining a meeting agenda comprises receiving agenda item indicators indicating a start time and an end time of the agenda items.

4. A meeting management method according to claim 1, wherein the receiving at least one progress indicator comprises receiving a timing indicator indicating a current meeting time.

5. A meeting management method according to claim 1, wherein the receiving at least one progress indicator comprises receiving an agenda item completion indicator indicating that an agenda item is completed.

6. A meeting management method according to claim 5, wherein the at least one progress indicator comprises at least one of a meeting schedule modification indicator and an agenda item schedule modification indicator.

7. A meeting management method according to claim 6, further comprising, if the at least one progress indicator includes a meeting schedule modification indicator:
modifying at least one of a meeting start time and a meeting end time of the meeting by a time interval (meeting modification interval) that corresponds to the meeting schedule modification indicator; and
modifying a scheduled timing of at least one of the agenda items that has not been completed (uncompleted agenda item) by a time interval (item modification interval) that corresponds to the meeting interval.

8. A meeting management method according to claim 7, further comprising, if the at least one progress indicator includes an agenda item time modification indicator:
modifying a scheduled timing of the agenda item by a time interval (item modification interval) that corresponds to the agenda item time modification indicator; and
modifying a meeting end time of the meeting by a time interval that corresponds to the agenda item time modification indicator.

9. A meeting management method according to claim 1, further comprising:
if the at least one progress indicator indicates that at least one of a scheduled agenda item start time and an agenda item end time will occur within a predetermined time interval, providing a corresponding proximity alert to one or more of the participants.

10. A meeting management method according to claim 9, wherein the at least one progress indicator includes at least two progress indicators, each progress indicator corresponding to a predetermined time interval that is greater than or equal to zero.

11. A meeting management method according to claim 1, further comprising:
presenting to at least one of the participants one or more agenda indicia corresponding to one or more of the at least one progress indicator and the automatic rescheduling if a corresponding agenda indicia is not yet presented; and
modifying an agenda indicia presentation to at least one of the participants corresponding to one or more of the at least one progress indicator and the automatic rescheduling if a corresponding agenda indicia has been presented.

12. A machine-readable medium having stored thereon instructions for causing a test optimization system to perform the steps of:
determining a meeting agenda of a meeting of at least two participants, the meeting agenda indicating a scheduled timing of one or more agenda items to be conducted during a meeting and a scheduled timing of the meeting;
receiving at least one progress indicator indicating at least one of a timing event and an agenda event; and
automatically rescheduling at least one of the agenda items if the at least one progress indicator indicates that an agenda item has been completed at a time other than its scheduled end time.

13. A machine-readable medium according to claim 12, wherein the receiving at least one progress indicator comprises receiving an agenda item completion indicator indicating that an agenda item is completed.

14. A machine-readable medium according to claim 13, wherein the at least one progress indicator comprises at least one of a meeting schedule modification indicator and an agenda item schedule modification indicator.

15. A machine-readable medium according to claim 23, further comprising, if the at least one progress indicator includes a meeting schedule modification indicator:
modifying at least one of a meeting start time and a meeting end time of the meeting by a time interval (meeting modification interval) that corresponds to the meeting schedule modification indicator; and
modifying a scheduled timing of at least one of the agenda items that has not been completed (uncompleted agenda item) by a time interval (item modification interval) that corresponds to the meeting interval.

16. A meeting management system, comprising:
determining means for determining a meeting agenda of a meeting of at least two participants, the meeting agenda indicating a scheduled timing of one or more agenda items to be conducted during a meeting and a scheduled timing of the meeting;
receiving means for receiving at least one progress indicator indicating at least one of a timing event and an agenda event; and
rescheduling means for automatically rescheduling at least one of the agenda items if the at least one progress indicator indicates that an agenda item has been completed at a time other than its scheduled end time.

17. A meeting management method, comprising:
determining a meeting agenda of a meeting of at least two participants, the meeting agenda indicating a scheduled timing of one or more agenda items to be conducted during a meeting and a scheduled timing of the meeting;
receiving an agenda modification including at least one of a meeting modification and an agenda item modification from a participant;
modifying a scheduled timing of one or more uncompleted agenda items according to agenda modification;
modifying the scheduled timing of the meeting according to the agenda modification if the agenda modification corresponds with a modification of the scheduled timing of the meeting.

18. A meeting management apparatus, comprising:
means for generating a progress bar for receiving timing information and indicating a time progression corresponding to a conducting of a meeting; and
means for generating agenda indicia disposed proximately to the progress bar, the agenda indicia corresponding to respective agenda items of the meeting and positioned to indicate a relative time for scheduled conducting of the agenda items during the meeting.

19. A meeting management apparatus according to claim 36, wherein at least one of the progress bar and the agenda indicia are implemented as a graphical user interface.

20. A meeting management apparatus according to claim 36, wherein the meeting includes at least one of a local participant and a remote participant.

21. A meeting management system according to claim 36, wherein the progress bar is operable responsive to a user information presentation control by presenting a current time.
